(19) United States
(12) Patent Application Publication
(10) Pub. No.: US 2013/0268857 A1
(43) Pub. Date: Oct. 10, 2013

(54) MULTIMEDIA CONTENT PROVIDING DEVICE, MULTIMEDIA CONTENT PROVIDING METHOD, AND RELEVANT COMPUTER PROGRAM PRODUCT

(71) Applicant: REALTEK SEMICONDUCTOR CORP., Hsinchu (TW)

(72) Inventors: Chin Huang HSU, Hsinchu (TW); Siu-Leong YU, Zhubei City (TW); Shih-Chun WEI, Hsinchu City (TW); Chen MA, San Jose, CA (US); Sun Chien CHIU, Hsinchu (TW)

(73) Assignee: Realtek Semiconductor Corp., Hsinchu (TW)

(21) Appl. No.: 13/857,638

(22) Filed: Apr. 5, 2013

Related U.S. Application Data
(63) Continuation-in-part of application No. 13/624,582, filed on Sep. 21, 2012.
(60) Provisional application No. 61/620,988, filed on Apr. 6, 2012.
(60) Provisional application No. 61/746,572, filed on Dec. 28, 2012.

(30) Foreign Application Priority Data
Aug. 28, 2012 (TW) 101131261
Oct. 4, 2012 (TW) 101136764
Mar. 20, 2013 (TW) 102109832

(51) Int. Cl. G06F 3/0481

(52) U.S. Cl. CPC G06F 3/0481
USPC 715/716

(57) ABSTRACT

A multimedia providing device includes a communication device, an access link generating device, a play control device, and an information display control device. The communication device receives a multimedia content, a multimedia information, a display time code, and an identification number of a recipient. The access link generating device generates the access link of the multimedia content and transmits it to the recipient. The play control device receives a play instruction corresponding to the multimedia content and configures the multimedia content to be transmitted to a multimedia content display device. The information display control device configures a multimedia information providing device to transmit the multimedia information to a portable information display device according to the display time code and the identification number of the recipient. Therefore, the portable information display device displays the multimedia information when the multimedia content display device displays a predetermined image frame of the multimedia content.

### CROSS-REFERENCE TO RELATED APPLICATIONS

This application claims the benefit of priority to U.S. Provisional Application Ser. No. 61/620,988, filed on Apr. 6, 2012; and the benefit of priority to U.S. Provisional Application Ser. No. 61/746,572, filed on Dec. 28, 2012. This application is a Continuation-In-Part of and claims the benefit of priority to U.S. patent application Ser. No. 13/624,582, filed on Sep. 21, 2012. This application claims the benefit of priority to Patent Application No. 101131261, filed in Taiwan on Aug. 28, 2012; the benefit of priority to Patent Application No. 101136764, filed in Taiwan on Oct. 4, 2012; and the benefit of priority to Patent Application No. 102109832, filed in Taiwan on Mar. 20, 2013. The entirety of the aforementioned applications is incorporated herein by reference for all purposes.

### BACKGROUND

The disclosure generally relates to a multimedia content providing device and, more particularly, to the multimedia content providing device which may transmit the multimedia content and the related multimedia information at the proper time.

Along with the rapid development of the image capture devices and the communication technology, many people like to take pictures, video, and other multimedia content for sharing with friends. Many multimedia sharing websites and multimedia services are blooming accordingly. For example, the multimedia services may be used to convey performers' news and activities, greetings and compliments between friends, and love messages between lovers for providing impressive effects.

Moreover, as the prevalence of portable communication devices, many people are used to spending more time watching multimedia contents and multimedia information on the smartphones, tablet computers, notebook computers, etc. The portable communication device has played an essential role in the interpersonal relationship and changed people's life habits. For example, many people are used to utilizing the tablet computer or the smartphone while watching television or videos. Even in the face-to-face meetings, people are spending more time on the portable devices than communicating with others. Nowadays, people often put more focus on their portable devices than other things.

When the multimedia contents are demonstrated in the traditional styles (e.g., on television), the audio and video effects are more attractive. The target viewers may, however, miss the focus of the multimedia content when they happen to be absent or focus on something else, and the effect of the multimedia services is greatly reduced. For example, imagine how it would be disappointing if a man utilizes the multimedia service to propose to his girlfriend and the girl miss the climax of the proposal multimedia content.

On the other side, although people will be more focused when the multimedia content are displayed on the portable devices, the viewing experience is often limited by the screen size and the hardware of the portable device. Therefore, people have difficulties finding the required multimedia services to effectively convey their expression to the target recipient.

### SUMMARY

In view of the foregoing, it may be appreciated that a substantial need exists for methods and apparatuses that mitigate or reduce the problems above.

An example embodiment of a multimedia content providing device is disclosed, comprising: a communication device, configured to operably receive a multimedia content, a multimedia information, a display time code, and an identification number of a recipient; an access link generating device, configured to operably generate an access link for the multimedia content and transmit the access link to the recipient; a play control device configured to operably receive a play instruction corresponding to the multimedia content, and configure the multimedia content to be transmitted to a multimedia content display device in response to the play instruction so that the multimedia content display device displays a predetermined image frame of the multimedia content at a time indicated by the display time code; and an information display control device, configured to operably configure a multimedia information providing device to transmit the multimedia information to a portable information display device according to the display time code and the identification number of the recipient so that the portable information display device displays the multimedia information when the multimedia content display device displays the predetermined image frame; wherein the multimedia information is related to an object of the predetermined image frame; the object comprises at least one of a character, an article, a sound, a scene, and a time of the predetermined image frame; the multimedia information comprises at least one of a text, a sound, an image, a vibration, and a scent; and the identification number of the recipient is associated with the portable information display device.

Another example embodiment of a computer program product is disclosed, which is stored in a non-transitory computer readable medium, when executed by a processing circuit of a multimedia content providing device, enabling the multimedia content providing device to perform a multimedia content providing operation, the multimedia content providing operation comprising: receiving a multimedia content, a multimedia information, a display time code, and an identification number of a recipient; generating an access link for the multimedia content and transmitting the access link to the recipient; receiving a play instruction corresponding to the multimedia content; transmitting the multimedia content to a multimedia content display device in response to the play instruction so that the multimedia content display device displays a predetermined image frame of the multimedia content at a time indicated by the display time code; and configuring a multimedia information providing device to transmit the multimedia information to a portable information display device according to the display time code and the identification number of the recipient so that the portable information display device displays the multimedia information when the multimedia content display device displays the predetermined image frame; wherein the multimedia information is related to an object of the predetermined image frame; the object comprises at least one of a character, an article, a sound, a scene, and a time of the predetermined image frame; the multimedia information comprises at least one of a text, a sound, an image, a vibration, and a scent; and the identification number of the recipient is associated with the portable information display device.

Another example embodiment of a multimedia content providing method is disclosed, comprising: receiving a multimedia content, a multimedia information, a display time code, and an identification number of a recipient; generating an access link for the multimedia content and transmitting the access link to the recipient; receiving a play instruction corresponding to the multimedia content; transmitting the multimedia content to a multimedia content display device in response to the play instruction so that the multimedia content display device displays a predetermined image frame of the multimedia content at a time indicated by the display time code; and configuring a multimedia information providing device to transmit the multimedia information to a portable information display device according to the display time code and the identification number of the recipient so that the portable information display device displays the multimedia information when the multimedia content display device displays the predetermined image frame; wherein the multimedia information is related to an object of the predetermined image frame; the object comprises at least one of a character, an article, a sound, a scene, and a time of the predetermined image frame; the multimedia information comprises at least one of a text, a sound, an image, a vibration, and a scent; and the identification number of the recipient is associated with the portable information display device.

Both the foregoing general description and the following detailed description are examples and explanatory only, and are not restrictive of the invention as claimed.

### BRIEF DESCRIPTION OF THE DRAWINGS

FIG. 1 shows a simplified functional block diagram of a multimedia system according to one embodiment of the present disclosure.

FIG. 2 shows a simplified flowchart of an operation method of the multimedia system in FIG. 1 according to one embodiment of the present disclosure.

### DETAILED DESCRIPTION

Reference is made in detail to embodiments of the invention, which are illustrated in the accompanying drawings. The same reference numbers may be used throughout the drawings to refer to the same or like parts, components, or operations.

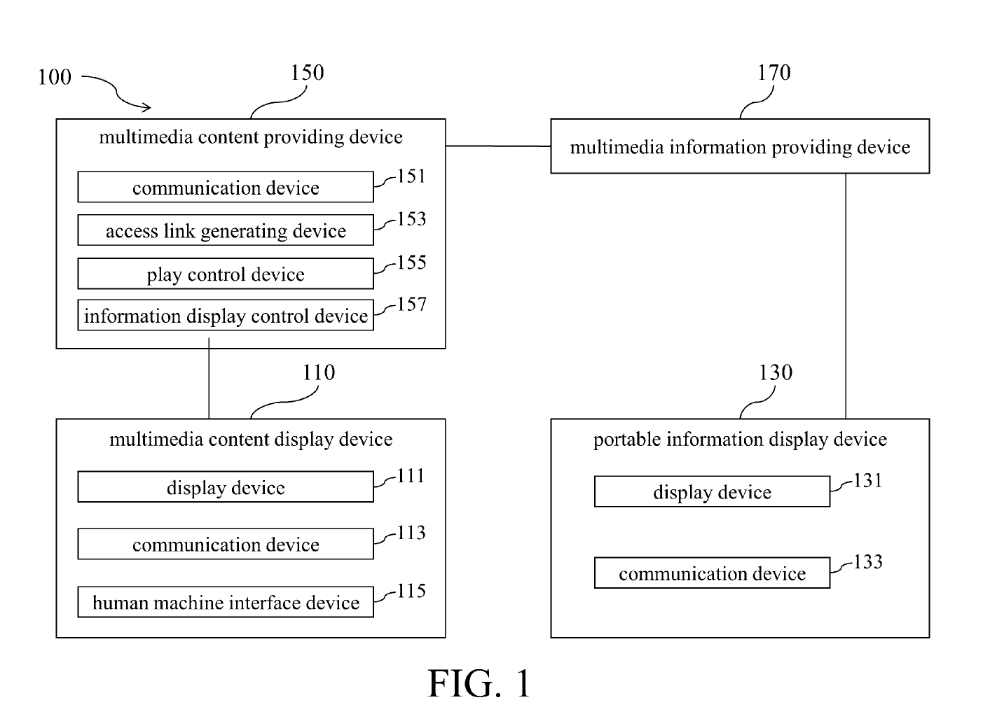

FIG. 1 shows a simplified functional block diagram of a multimedia system 100 according to one embodiment of the present disclosure. The multimedia system 100 comprises a multimedia content display device 110, a portable information display device 130, a multimedia content providing device 150, and a multimedia information providing device 170. For the purposes of conciseness and clear explanation, other components and connections thereof are omitted in FIG. 1.

The multimedia content display device 110 comprises a display device 111, a communication device 113, and a human machine interface device 115. For example, the multimedia content display device 110 may be realized with a computer, a smart TV, a multimedia player, or other suitable multimedia content display devices. The display device 111 may be realized with a flat panel display, a projector, or other suitable display devices. The communication device 113 may be realized with any suitable wired communication devices and/or wireless communication devices. The human machine interface device 115 may comprise a keyboard, a mouse, a touchpad, an image capture device, etc.

The portable information display device 130 comprises a display device 131 and a communication device 133. The display device 131 may be realized with a flat panel display, a projector, or other suitable display devices. The communication device 133 may be realized with any suitable wireless communication devices. For example, the portable information display device 130 may be realized with a smartphone, a tablet computer, etc.

The multimedia content providing device 150 comprises a communication device 151, an access link generating device 153, a play control device 155, and an information display control device 157. In FIG. 1, the multimedia content providing device 150 is illustrated with a functional box for conciseness. In practical implementation, the multimedia content providing device 150 may be realized with one or more devices, e.g., multiple computers with network connectivity.

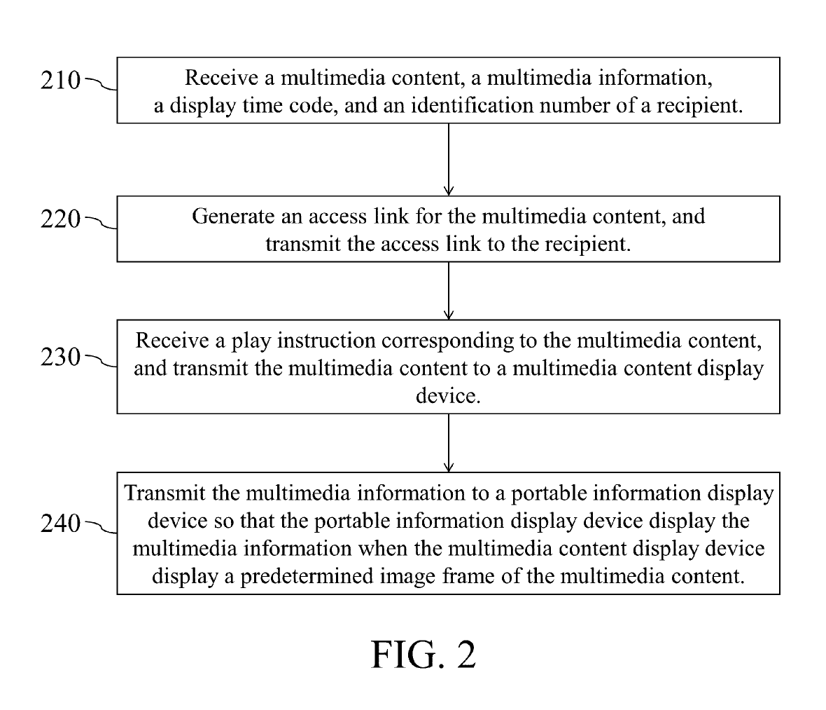

FIG. 2 shows a simplified flowchart of an operation method of the multimedia system 100 according to one embodiment of the present disclosure. The operations of the multimedia system 100 are further explained below with FIGS. 1 and 2.

In the operation 210, the multimedia content providing device 150 receives a multimedia content, a multimedia information, a display time code, and an identification number of a recipient through the communication device 151 from a sender.

The multimedia content may comprise an image, a video, and/or an audio. The multimedia content comprises one or more image frames. The image frame comprises one or more objects, and the object comprises at least one of a character, an article, a sound, a scene, and a time of the image frame.

The display time code is associated with one or more predetermined image frames. The display time code may be associated with the predetermined image frame to be displayed at a time relative to a marker or at a specific time. For example, in one embodiment, the display time code is associated with the image frame of the multimedia content to be displayed at 8:00 AM on Jan. 1, 2013. In another embodiment, the display time code is associated with the image frames of the multimedia content to be displayed between the fifth minute and the seventh minute after the multimedia content starts to be displayed. In another embodiment, the display time code is associated with the image frame of the multimedia content which is displayed in one minute after the recipient performs a click operation.

The multimedia information is used to convey the expression of the sender to the recipient, and is related to one or more objects of the predetermined image frame(s). The multimedia information may comprise at least one of a text, a sound, an image, a vibration, and a scent. For example, the multimedia information may be transmitted to the recipient through the short message service (SMS) or the multimedia messaging service of the mobile phones and/or through the instant messaging software service running on the portable information display device 130.

The identification number of the recipient is associated with the portable information display device 130 so that the multimedia content providing device 150 may transmit the multimedia information to the portable information display device 130 according to the portable information display device 130. In one embodiment, when the portable information display device 130 is realized with a smartphone, the identification number of the recipient may be configured to be the phone number of the smartphone. In another embodiment, the identification number of the recipient may be configured to be the identification number and/or the username of the instant messaging software service.

In the operation 220, the access link generating device 150 of the multimedia content providing device 150 generates an access link for the multimedia content and transmits the access link to the recipient. For example, the access link generating device 153 may generate a hyperlink, a uniform resource locator (URL), a quick response code (QR code), or other suitable access links for the multimedia content. The access link generating device 153 transmits the access link of the multimedia content to the recipient through the communication device 151 or other suitable communication approaches. Thus, the recipient may play the multimedia content through the access link.

In the operation 230, the play control device 155 receives a play instruction corresponding to the multimedia content. The play control device 155 configures the multimedia content to be transmitted to the multimedia content display device 110 so that the multimedia content display device 110 may display the predetermined image frame of the multimedia content on the display device 111 at the time indicated by the display time code. For example, the recipient enters a click input signal on the access link of the multimedia content through the human machine interface device 115 of the multimedia content display device 110, and accordingly transmits a play instruction corresponding to the multimedia content to the multimedia content providing device 150 through the communication 113. The multimedia content providing device 150 receives the play instruction through the communication device 151, and the play control device 155 transmits the multimedia content to the multimedia content display device 110 through the communication device 151.

In the operation 240, the information display control device 157 configures the multimedia information providing device 170 to transmit the multimedia information to the portable information display device 130 according to the display time code and the identification number of the recipient. Therefore, the portable information display device 130 may display the multimedia information on the display device 131 when the display device 111 of multimedia content display device 110 displays the predetermined image frame at the time indicated by the display time code.

In the above embodiments, the order of performing the above operations may be adjusted according to different design considerations. For example, the transmission of the multimedia information in the operation 240 may also be performed in the operation 220 or in the operation 230. In one embodiment, the information display control device 157 may transmits the multimedia information and the display time code to the multimedia information providing device 170 near the time indicated by the display time code so that the multimedia information providing device 170 may transmit the multimedia information to the portable information display device 130 at the time indicated by the display time code. Therefore, the portable information display device 130 may display the multimedia information on the display device 131 when the display device 111 of multimedia content display device 110 displays the predetermined image frame at the time indicated by the display time code. In another embodiment, in a first time interval, the information display control device 157 configures the multimedia information to be transmitted to and stored in the multimedia information providing device 170 in advance. In a later second time interval, the information display control device 157 configures the multimedia information providing device 170 to transmit the multimedia information to the portable information display device 130 at the time indicated by the display time code. Thus, the portable information display device 130 may display the multimedia information when the multimedia content display device 110 displays the predetermined image frame. The second time interval is configured to be later than the first time interval. Moreover, the second time interval may be configured to be earlier than the displaying of the predetermined image frame on the multimedia content display device 110 with a predetermined time (e.g., three minutes earlier) so that the portable information display device 170 may have enough time to perform the relevant operations.

In above embodiments, the multimedia content providing device 150 receives the multimedia content, the multimedia information, the display time code, and the identification number of the recipient through the communication device 151 in the operation 210. In other embodiments, the multimedia content providing device 150 may comprises a memory reader device and a human machine interface device (both not shown in FIG. 1) for receiving the multimedia content, the multimedia information, the display time code, and the identification number of the recipient form the sender. For example, the multimedia content providing device 150 may receive the multimedia content from the sender's memory card through the memory reader device, and receive the multimedia information, the display time code, and the identification number of the recipient inputted by the sender through the human machine interface device. In other embodiment, the multimedia content providing device 150 may comprise a storage device for storing multimedia content, multimedia information, and display time code. The sender may select or edit the multimedia content, the multimedia information, the display time code, and the identification number of the recipient through the human machine interface device.

In the above embodiment, the multimedia content providing device 150 receives the multimedia content from the sender through the communication device 151 in the operation 210. In other embodiment, the multimedia content may be stored in other storage servers or websites. The sender provides the access link of the multimedia content stored in other storage servers or websites to the multimedia content providing device 150, and the access link generating device 153 transmits the access link of the multimedia content to the recipient in the operation 220.

The communication device 151, the access link generating device 153, the play control device 155, and the information display control device 157 of the multimedia content providing device 150 may be respectively realized with software, hardware, firmware, and the cooperation thereof. In one embodiment, the communication device 151, the access link generating device 153, the play control device 155, and the information display control device 157 are realized with integrated circuit elements and/or discrete circuit elements. In another embodiment, the communication device 151 is realized with any suitable wired or wireless communication device. The access link generating device 153, the play control device 155, and the information display control device 157 are realized with software executed by the processing circuit (e.g., microcontroller, signal processor, and central processing unit) of the multimedia content providing device 150 for performing the operations above.

In the above embodiments, the multimedia content providing device 150 transmits the multimedia content to the multimedia content display device 110 so that the recipient may enjoy the multimedia content. Moreover, the multimedia content providing device 150 configure the multimedia information providing device 170 to transmit the multimedia information to the portable information display device 170 at the proper time. Therefore, the portable information display device 130 may display the multimedia information on the display device 131 when the display device 111 of multimedia content display device 110 displays the predetermined image frame at the time indicated by the display time code. Not only may the recipient duly receive the sender's message, the viewing quality of the multimedia content may still maintained.

In the above embodiment, the recipient may watch the multimedia content on the multimedia content display device 110 for enjoying the splendid audio and video effect of the multimedia content display device 110. Moreover, the recipient may be timely notified and receive the multimedia information from the portable information display device 130 so as not to miss the focus of the multimedia content.

Moreover, in the above embodiment, the greetings, the apologies, the love announcements, the compliments, and other multimedia information may be timely presented associated with the scene, the plot, the characters, the articles, etc. appeared in the multimedia content. Therefore, the viewing experience may be greatly enhanced.

The above embodiment may be easily integrated with computer network architectures and telecommunication architectures. Therefore, the multimedia content providers and the telecommunication operators may combines the information flow, the cash flow, and other relevant service to provide the integrated multimedia content and multimedia information service for the users.

In the drawings, the size and relative sizes of some elements may be exaggerated or simplified for clarity. Accordingly, unless the context clearly specifies, the shape, size, relative size, and relative position of each element in the drawings are illustrated merely for clarity, and not intended to be used to restrict the claim scope.

Certain terms are used throughout the description and the claims to refer to particular components. One skilled in the art appreciates that a component may be referred to as different names. This disclosure does not intend to distinguish between components that differ in name but not in function. In the description and in the claims, the term “comprise” is used in an open-ended fashion, and thus should be interpreted to mean “include, but not limited to.” The phrases “be coupled with,” “couples with,” and “coupling with” are intended to compass any indirect or direct connection. Accordingly, if this disclosure mentioned that a first device is coupled with a second device, it means that the first device may be directly or indirectly connected to the second device through electrical connections, wireless communications, optical communications, or other signal connections with/without other intermediate devices or connection means.

The term “and/or” may comprise any and all combinations of one or more of the associated listed items. In addition, the singular forms “a,” “an,” and “the” herein are intended to comprise the plural forms as well, unless the context clearly indicates otherwise.

Other embodiments of the invention will be apparent to those skilled in the art from consideration of the specification and practice of the invention disclosed herein. It is intended that the specification and examples be considered as exemplary only, with a true scope and spirit of the invention indicated by the following claims.

What is claimed is:

1. A multimedia content providing device, comprising:
a communication device, configured to operably receive a multimedia content, a multimedia information, a display time code, and an identification number of a recipient;
an access link generating device, configured to operably generate an access link for the multimedia content and transmits the access link to the recipient;
a play control device configured to operably receive a play instruction corresponding to the multimedia content, and configure the multimedia content to be transmitted to a multimedia content display device in response to the play instruction so that the multimedia content display device displays a predetermined image frame of the multimedia content at a time indicated by the display time code; and
an information display control device, configured to operably configure a multimedia information providing device to transmit the multimedia information to a portable information display device according to the display time code and the identification number of the recipient so that the portable information display device displays the multimedia information when the multimedia content display device displays the predetermined image frame;
wherein the multimedia information is related to an object of the predetermined image frame; the object comprises at least one of a character, an article, a sound, a scene, and a time of the predetermined image frame; the multimedia information comprises at least one of a text, a sound, an image, a vibration, and a scent; and the identification number of the recipient is associated with the portable information display device.

2. The multimedia content providing device of claim 1, wherein the information display control device configures the multimedia information and the display time code to be transmitted to the multimedia information providing device so that the multimedia information providing device transmits the multimedia information to the portable information display device according to the display time code and the portable information display device displays the multimedia information when the multimedia content display device displays the predetermined image frame.

3. The multimedia content providing device of claim 1, wherein in a first time interval, the information display control device configures the multimedia information to be transmitted to and stored in the multimedia information providing device; in a second time interval, the information display control device configures the multimedia information providing device to transmit the multimedia information to the portable information display device so that the portable information display device displays the multimedia information when the multimedia content display device displays the predetermined image frame; and the second time interval is configured to be earlier than the displaying of the predetermined image frame on the multimedia content display device with a predetermined time, and later than the first time interval.

4. The multimedia content providing device of claim 1, wherein the information display control device configures the multimedia information providing device to transmit the multimedia information to the portable information display device through at least one of a short message service and a multimedia messaging service.

5. The multimedia content providing device of claim 1, wherein the information display control device configures the multimedia information providing device to transmit the multimedia information to the portable information display device through an instant messaging software service.

6. A computer program product stored in a non-transitory computer readable medium, when executed by a processing circuit of a multimedia content providing device, enabling the multimedia content providing device to perform a multimedia content providing operation, the multimedia content providing operation comprising:
receiving a multimedia content, a multimedia information, a display time code, and an identification number of a recipient;
generating an access link for the multimedia content and transmitting the access link to the recipient;
receiving a play instruction corresponding to the multimedia content;
transmitting the multimedia content to a multimedia content display device in response to the play instruction so that the multimedia content display device displays a predetermined image frame of the multimedia content at a time indicated by the display time code; and
configuring a multimedia information providing device to transmit the multimedia information to a portable information display device according to the display time code and the identification number of the recipient so that the portable information display device displays the multimedia information when the multimedia content display device displays the predetermined image frame;
wherein the multimedia information is related to an object of the predetermined image frame; the object comprises at least one of a character, an article, a sound, a scene, and a time of the predetermined image frame; the multimedia information comprises at least one of a text, a sound, an image, a vibration, and a scent; and the identification number of the recipient is associated with the portable information display device.

7. The computer program product of claim 6, wherein the multimedia content providing operation further comprises:
configuring the multimedia information and the display time code to be transmitted to the multimedia information providing device so that the multimedia information providing device transmits the multimedia information to the portable information display device according to the display time code and the portable information display device displays the multimedia information when the multimedia content display device displays the predetermined image frame.

8. The computer program product of claim 6, wherein the multimedia content providing operation further comprises:
in a first time interval, configuring the multimedia information to be transmitted to and stored in the multimedia information providing device;
in a second time interval, configuring the multimedia information providing device to transmit the multimedia information to the portable information display device so that the portable information display device displays the multimedia information when the multimedia content display device displays the predetermined image frame; and
the second time interval is configured to be earlier than the displaying of the predetermined image frame on the multimedia content display device with a predetermined time, and later than the first time interval.

9. The computer program product of claim 6, wherein the multimedia content providing operation further comprises:
configuring the multimedia information providing device to transmit the multimedia information to the portable information display device through at least one of a short message service and a multimedia messaging service.

10. The computer program product of claim 6, wherein the multimedia content providing operation further comprises:
configuring the multimedia information providing device to transmit the multimedia information to the portable information display device through an instant messaging software service.

11. A multimedia content providing method, comprising:
receiving a multimedia content, a multimedia information, a display time code, and an identification number of a recipient;
generating an access link for the multimedia content and transmitting the access link to the recipient;
receiving a play instruction corresponding to the multimedia content;
transmitting the multimedia content to a multimedia content display device in response to the play instruction so that the multimedia content display device displays a predetermined image frame of the multimedia content at a time indicated by the display time code; and
configuring a multimedia information providing device to transmit the multimedia information to a portable information display device according to the display time code and the identification number of the recipient so that the portable information display device displays the multimedia information when the multimedia content display device displays the predetermined image frame;
wherein the multimedia information is related to an object of the predetermined image frame; the object comprises at least one of a character, an article, a sound, a scene, and a time of the predetermined image frame; the multimedia information comprises at least one of a text, a sound, an image, a vibration, and a scent; and the identification number of the recipient is associated with the portable information display device.

12. The multimedia content providing method of claim 11, further comprising:
configuring the multimedia information and the display time code to be transmitted to the multimedia information providing device so that the multimedia information providing device transmits the multimedia information to the portable information display device according to the display time code and the portable information display device displays the multimedia information when the multimedia content display device displays the predetermined image frame.

13. The multimedia content providing method of claim 11, further comprising:
in a first time interval, configuring the multimedia information to be transmitted to and stored in the multimedia information providing device;
in a second time interval, configuring the multimedia information providing device to transmit the multimedia information to the portable information display device so that the portable information display device displays the multimedia information when the multimedia content display device displays the predetermined image frame; and
the second time interval is configured to be earlier than the displaying of the predetermined image frame on the multimedia content display device with a predetermined time, and later than the first time interval.

14. The multimedia content providing method of claim 11, further comprising:
configuring the multimedia information providing device to transmit the multimedia information to the portable information display device through at least one of a short message service and a multimedia messaging service.

15. The multimedia content providing method of claim 11, further comprising:
configuring the multimedia information providing device to transmit the multimedia information to the portable information display device through an instant messaging software service.
